(19) United States
(12) Patent Application Publication
(10) Pub. No.: US 2002/0184194 A1
(43) Pub. Date: Dec. 5, 2002

(54) Multipurpose web-enabled browser

(75) Inventor: Young-Jun Yoon, Poughkeepsie, NY (US)

Correspondence Address: William Kinnaman, Jr., IBM Corporation,, Intellectual Property Law Department, 2455 South Road, M/S P386, Poughkeepsie, NY, 12601, US

(73) Assignee: INTERNATIONAL BUSINESS MACHINES CORPORATION, ARMONK, NY

(21) Appl. No.: 09/867,818

(22) Filed: May 30, 2001

(51) Int. Cl. G06F 7/00

(52) U.S. Cl. 707/3

(57) ABSTRACT

A hypertext browser for retrieving data from a selected one of a plurality of databases. One of the databases may comprise an Interface Repository, while others may store Naming contexts or Java classes. Each of a plurality of browser components is operable to retrieve data from a corresponding one of the databases. Upon receiving a hypertext request from a requester specifying data contained in one of the databases, a main browser servlet residing on a server machine directs the request to the browser component corresponding to that database to permit the browser component to retrieve the data specified in the request. The request may specify one of the browser components, in which case the main servlet directs the request to the browser component specified in the request. The main servlet generates common header and footer portions of a hypertext reply to the requester, while the browser component generates a browser-specific portion of the hypertext reply to the requester. Each browser component has a translator component associated therewith that intermediates between the browser component and the database and generates a request-specific portion of the browser-specific portion of the hypertext reply. The browser component itself generates a non-request-specific portion of the browser-specific portion of the hypertext reply to the requester.

### BACKGROUND OF THE INVENTION

1. Field of the Invention

This invention relates to a hypertext browser for retrieving data from a selected one of a plurality of databases, such as an Interface Repository or a database for storing Naming contexts or Java classes.

2. Description of the Related Art

The following terms and acronyms are used in this specification. Definitions of these and other terms may also be found in the IBM publication WebSphere Application Server Enterprise Edition Component Broker Glossary, SC09-4450-00 (August 1999), incorporated herein by reference.

CB/390: OS/390® Component Broker. An IBM application server that is now a part of the IBM WebSphere® family

CGI: Common Gateway Interface. A server program that can process standard input and standard output loaded by a Web server when the request comes in via an HTTP (Hypertext Transfer Protocol) request.

CORBA: Common Object Request Broker Architecture. A specification produced by the Object Management Group (OMG) that presents standards for various types of Object Request Brokers (such as client-resident ORBs, server-based ORBs, system-based ORBs, and library-based ORBs). Implementation of CORBA standards enables ORBs from different software vendors to interoperate. See ORB. DB2®: DATABASE 2™. An IBM relational database management system (RDBMS).

EJB: Enterprise JavaBean. Similar to CORBA server object but focused more for customers that are geared toward using the RMI interface that the Java programming language introduces for client/server programming. (Java and all Java-based trademarks are trademarks of Sun Microsystems, Inc. in the United States, other countries, or both.) EJBObject: Enterprise JavaBean Object. End user interface of EJB

IDL: Interface Definition Language. A language-neutral way of specifying the server object's interface that can be backed by CORBA compliant application servers. Developed by OMG, it defines the types of objects, their attributes, the methods they export, and the method parameters. It is a language by which objects tell their potential clients what operations are available and how they should be invoked. The CORBA IDL is a subset of ANSI C++ with additional constructs to support distribution. The IDL is a purely declarative language that uses the C++ syntax for constant, type, and operation definitions, and it does not include any control structures or variables. CORBA IDL can be used to specify component attributes (or public variables), the parent class it inherits from, the exceptions it raises, typed events, pragmas for generating globally unique identifiers for the interfaces, and the methods an interface supports, including the input and output parameters and their data types.

IIOP: Internet Inter-Orb Protocol. A protocol that is mandatory for all CORBA 2.0-compliant platforms. The initial phase of the project is an infrastructure consisting of: (1) an IIOP to HTTP gateway that allows CORBA clients to access WWW resources; (2) an HTTP to IIOP gateway to enable WWW clients to access CORBA resources; (3) a Web server that makes resources available by both HOP and HTTP; and (4) Web browsers that can use IIOP as their native protocol.

IOR: Interoperable Object Reference. An object reference used by the IIOP protocol that can uniquely identify any IIOP-enabled objects from any client/server code running in any machine with CORBA-compliant application server enabled.

IR: Interface Repository. A part of a CORBA ORB service that stores a server object's interface (IDL). It is a database that Component Broker optionally creates, providing persistent storage of objects that represent the major elements of interface definitions. Creation and maintenance of the IR is based on information supplied in the Interface Definition Language source file.

LDAP: Lightweight Directory Access Protocol. A protocol for accessing directory services on a network (RFC 1823).

OMG: Object Management Group. A nonprofit consortium whose purpose is to promote object-oriented technology and the standardization of that technology. OMG was formed to help reduce the complexity, lower the costs, and hasten the introduction of new software applications.

ORB: Object Request Broker. A communications protocol for conveying messages between objects. A CORBA term designating the means by which objects transparently make requests (that is, invoke methods) and receive responses from objects, whether they are local or remote. An ORB is the implementation of an OMG specification which allows the distribution of objects across a system or network.

RMI: Remote Method Invocation. Provides for remote communication between programs written in Java, and allows an object running in one Java Virtual Machine (JVM) to invoke methods on an object running in another JVM.

Servlet: A small piece of Java code that a Web server loads to handle client request and server response. Its code stays resident in memory when the request terminates, plus it can chain a request to an another servlet.

Often it is desirable to be able to view, from a client machine, various objects stored in databases that are managed by a database manager running on a server. Such objects may include, for example, interface definitions, Naming contexts, and Java classes. While there exist specialized viewers for viewing each of these types of objects, they typically require the installation of software on the client machines. Not only does such client-side software consume system resources, but it must also be compatible with server-side programs and be maintained as well. What is desired, therefore, is the ability to view multiple types of objects stored in server databases while at the same time using thin clients and minimizing compatibility and maintenance concerns.

### SUMMARY OF THE INVENTION

In general, the present invention contemplates a hypertext browser for retrieving data from a selected one of a plurality of databases. One of the databases may comprise an Interface Repository, while others may store Naming contexts or Java classes. Each of a plurality of browser components is operable to retrieve data from a corresponding one of the databases. Upon receiving a hypertext request from a requester specifying data contained in one of the databases, a main browser servlet residing on a server machine directs the request to the browser component corresponding to that database to permit the browser component to retrieve the data specified in the request. The request may specify one of the browser components, in which case the main servlet directs the request to the browser component specified in the request. The main servlet generates common header and footer portions of a hypertext reply to the requester, while the browser component generates a browser-specific portion of the hypertext reply to the requester. Each browser component has a translator component associated therewith that intermediates between the browser component and the database and generates a request-specific portion of the browser-specific portion of the hypertext reply. The browser component itself generates a non-request-specific portion of the browser-specific portion of the hypertext reply to the requester.

A preferred embodiment of the present invention implements the various browsers and other components using IBM Component Broker, a server-side program. Component Broker is an OMG CORBA-compliant application server hosting CORBA/IIOP-enabled server objects providing client/server communication through a IIOP protocol. With an implementation of RMI/IIOP, RMI clients accessing Enterprise JavaBeans (EJBs) can also access CORBA/IIOP objects as well and vice versa. Using the present invention, an end user should be able to access the most current server object interfaces stored in the Interface Repository (IR) database as well as their IORs stored in a Naming server database using a Web browser.

In the preferred embodiment, servlets that run under a Web server have direct access to the Component Broker application servers that host the server objects; in the embodiment shown, these are Naming and Interface Repository (IR) objects. Servlets are also more efficient than CGI scripts because the server code stays resident in memory when the request terminates, so that it can handle subsequent requests much faster. Using these features, appropriate Java client programs (Java classes or Java Beans) can be used to generate a dynamic Web page each time a request flows over from the Web server via a HTTP request requesting the necessary servlet to execute. The present invention thus combines the power of executing servlets, helper Java classes, and IR and Naming server objects.

Because of the desire to avoid requiring the end user to install a client program or having the right versions of plug-ins for Web browsers, the disclosed embodiment uses simple HTML (Hypertext Markup Language) documents that can be generated dynamically using servlets. This architecture allows the clients to be as thin as possible, requiring only a Web browser capable of interpreting HTML documents sent via the HTTP protocol. The present invention can handle multiple users while executing all the main operations on the server side. This is a key feature of the present invention, since code running on the server side can be maintained without client access interruption. Thicker clients, on the other hand, would require periodic client-side updates.

The present invention provides a fast Web-based application (comprising servlets and/or JavaScripts in the embodiment shown) that can be used as a product front-end tool on Component Broker and similar applications to interact with the existing distributed application servers (e.g., Naming and Interface Repository) of such applications. In a preferred embodiment the present invention provides three major functions:

1. It provides a Web-enabled user interface for displaying the content of a particular interface in IDL format retrieved from an Interface Repository (IR) server, provided that the user inputs the repository ID of the interface in question. The user interface may remember repository IDs successfully used previously to assist the user in locating that interface information later. The output displayed on a Web page provides a clickable link to dynamically display the IDL information of the inherited interfaces as well as other definitions that are stored in an IR that has a valid repository ID associated with it.

2. It provides a Web-enabled user interface for displaying the content of any Naming context stored in a Naming server database. This browser may have a user interface that is similar to that of the IR browser described above. This user interface may allow the end user to start his or her search from the root of the Naming tree by initially showing all the children branches from the root Naming context. If the Naming context found is of type nobject, the IOR stored for that Naming context can be explored to retrieve the matching interface information from the Interface Repository. In this case, the interface may give the user a choice to switch from the Naming browser to the IR browser to show the interface information that the IOR represents.

3. It provides a Web-enabled user interface for displaying the content of a Java class or interface that is accessible at runtime (through CLASSPATH). This Java browser can be used along with the IR browser to go from an IDL interface to a matching Java class. If a Java class happens to be an EJBObject, then it can also be used to go from an EJBObject Java class display to a matching IDL interface display via the IR browser. In addition, when more and more EJBObjects are registered to a Component Broker application server, the invention may be implemented to recognize that a particular Naming context object is an EJBObject registered through ejbbind, so that it can jump either to an IDL interface display or to EJBObject Java class display.

### BRIEF DESCRIPTION OF THE DRAWINGS

FIG. 1 is a schematic block diagram of an information handling system incorporating the present invention.

FIG. 2 shows the interrelationships between the top-level components of the present invention.

FIG. 3 is a sequence diagram showing the interaction required between objects to construct the final HTTP response that the user receives at his or her end.

FIG. 4 shows the generic interaction that occurs in processing a user request in which a user submits a repository ID (repID) via a form submission.

FIG. 5 is a generic class diagram of the present invention.

FIG. 6 is a class diagram of the browser components of the present invention.

FIG. 7 is a class diagram of the translator components of the present invention.

FIG. 8 shows a possible layout of the browser display.

### DESCRIPTION OF THE PREFERRED EMBODIMENT

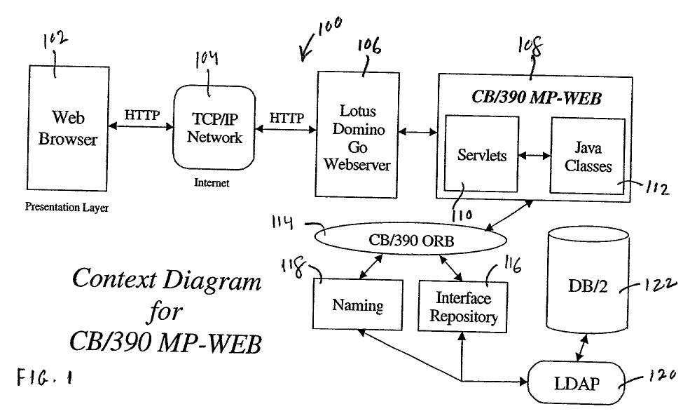

FIG. 1 is a schematic block diagram of an information handling system 100 incorporating the present invention. The system contains an HTML client (i.e., a Web browser) 102, which interacts via a TCP/IP (Transmission Control Protocol/Internet Protocol) connection 104 with an HTML server (or Web server) 106. Typically, HTML client 102 resides on a client machine (not separately shown), while Web server 106 resides on a server machine (not separately shown) along with the other server-side elements to be described.

While the particular platforms form no part of the present invention, in the embodiment shown, the client machine may be an Intel architecture machine running either a Microsoft Windows operating system or a UNIX-based operating system (such as Linux), while the server machine may be an IBM S/390® or zSeries™ server running an IBM OS/390® or z/OS™ operating system. (Microsoft, Windows, Windows NT, and the Windows logo are trademarks of Microsoft Corporation in the United States, other countries, or both. UNIX is a registered trademark of The Open Group in the United States and other countries. S/390, zSeries, OS/390, and z/OS are trademarks or registered trademarks of IBM Corporation, as indicated.) The particular Web browser 102 used likewise forms no part of the present invention, but may be Netscape Navigator, Microsoft Internet Explorer, Mosaic, or any other browser compliant with HTTP protocols. Similarly, while the particular Web server 106 forms no part of the present invention, a Lotus Domino™ Go Webserver is used in the embodiment shown.

Web server 106 functions in a conventional manner to provide HTML documents to Web browser 102 in response to HTTP requests from the browser. For conventional requests to retrieve static Web pages, Web server 106 runs more or less unassisted. More complicated requests, on the other hand, are handed off to one or more application servers, one of which, application server 108, is shown. Requests that are handed off to an application server are typically those requiring the dynamic construction of an HTML document, usually by querying a server database using query parameters supplied by the user. While the particular application server 108 forms no part of the present invention, in the embodiment shown the IBM WebSphere Application Server, Enterprise Edition, is used. The Enterprise Edition of WebSphere Application Server differs from the Standard Edition in that it includes, in addition to the usual components of WebSphere Application Server, OS/390 Component Broker. A description of the base edition of WebSphere Application Server may be found in the IBM publication WebSphere Application Server Standard Edition Planning, Installing, and Using, GC34-4806, incorporated herein by reference, while a description of OS/390 Component Broker may be found in the IBM publication WebSphere Application Server for OS/390 Component Broker Enterprise Edition Planning and Installation Guide, GA22-7325, also incorporated herein by reference. Further information may be found in the IBM publication WebSphere Application Server for OS/390 Getting Started, GA22-7331, incorporated herein by reference.

Application server 108 contains the basic components of the present invention, as described below. In general, these components are implemented as either servlets 110 or Java classes 112.

Application server 108 interacts with an object request broker (ORB) component 114 of Component Broker. ORB 114 in turn interacts with an Interface Repository (IR) server 116 and a Naming server 118, which are connected via a Lightweight Directory Access Protocol (LDAP) interface 120 to a database manager 122 (such as the IBM DB2 relational database manager) that directly accesses the objects of interest in the database.

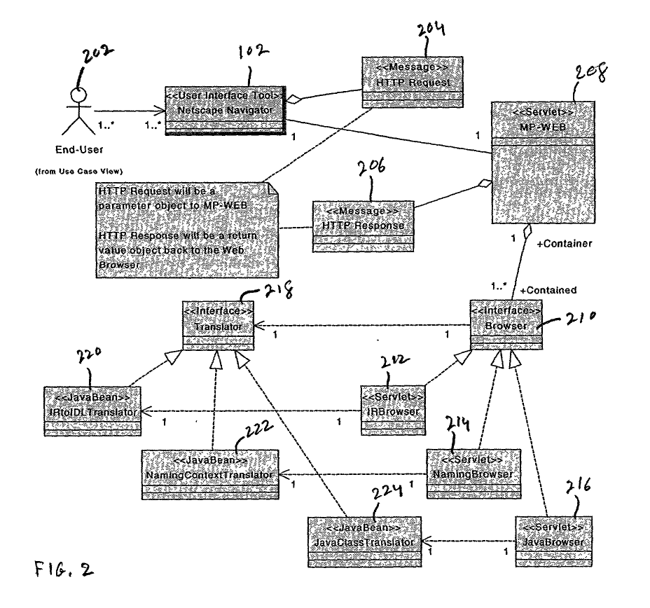

FIG. 2 shows the interrelationships between the top-level components of the present invention. With the exception of the Web browser 102, each of these components is an element of the CB/390 MP-WEB component 108 shown in FIG. 1

As shown in the figure, an end user 202 interacts with Web browser (Netscape Navigator) 102 to cause the Web browser 102 to build up an HTTP request object (HTTP Request) 204, which it sends to a main servlet (MP-WEB) 208. In response to the HTTP request object, MP-WEB servlet 208 builds up an HTTP response object (HTTP Response) 206, which it sends back to the Web browser 102.

A browser object (Browser) 210 is shown as an interface object having three subclasses that implement its interface. These comprise an Interface Repository (IR) browser servlet (IRBrowser) 212, a Naming browser servlet (NamingBrowser) 214, and a Java class browser servlet (JavaBrowser) 216. The browser object 210 is a contained object within the container of the MP-WEB servlet 208.

Browser object 210 interacts with a translator object (Translator) 218. Like browser object 210, translator object 218 is a generic interface object having three subclasses that implement its interface. These subclasses, which are implemented as JavaBeans in the embodiment shown, comprise an IR-to-IDL translator (IRtoIDLTranslator) 220, a Naming context translator (NamingContextTranslator) 222, and a Java class translator (JavaClassTranslator) 224. Translator interface 218 has a similar relationship with its subclasses 220-224 as browser interface 210 has with its subclasses 212-216. Each translator subclass is the dependent core JavaBean (acts as a Model object in MVC architecture) that provides the content to its corresponding browser instance.

Because of the presentation layer that has been selected, which is a plain HTML document, the user interface for the present invention has to stay within the bounds of the HTML capability. Although an HTML document may not provide all the interactive functionalities of certain alternatives, it currently has many features such as JavaScripts for client-side embedded code for dynamic interaction, cascading style sheets for customizing font styling, and <table> tags for providing layout management. For the present invention, performance and compatibility are more serious considerations than page layout. The present invention focuses more on performance for fast access, a thin client for easy server code upgrade, broader end user usage through a Web browser, and clear content display using a plain text.

The user interface for this invention provides all the features that were mentioned above, including the following: (1) an Interface Repository (IR) browser 212 that retrieves and displays the IR content of a valid IDLType by using the repository ID entered in IDL format; (2) a Naming browser 214 that retrieves and displays the Naming content given the Naming context name in string format; and (3) a Java class browser 216 that retrieves and displays the Java class or interface content given the name of the Java class or interface. In addition to or as an alternative to the three browsers shown, other browsers could be similarly implemented if desired. For example, one could have an LDAP browser for browsing the content of an LDAP directory where Interface Repository, Naming Service, and new EJB information is stored.

In the embodiment shown, each browser 212, 214 and 216 has a Home or Initial View button that displays an initial view for that browser. Thus, the Interface Repository (IR) browser 212 starts an initial view from a repository root which shows all the child modules or interfaces hanging off the root. The IR browser 212 enables clickable links for every valid IDL type displayed on the browser to display that type in detail and keeps a history of valid repository IDs entered since the beginning of a browsing session.

Similarly, the Naming browser 214 starts off with an initial view showing the children of a root Naming context. The Naming browser 214 enables clickable links for every Naming context displayed on the browser and keeps a history of valid Naming contexts entered since the beginning of a browsing session. Preferably, the Naming context with ncontext type branches out one level when clicked and nobject type transfers the user into the IR browser mode to display its interface information.

Finally, the Java browser 216 starts off with an initial view showing all the available packages and displays all the classes and interfaces for a particular package when clicked. The Java browser 216 enables clickable links for every user-defined type displayed on the browser to show its class or interface information and keeps a history of valid Java class and interface names entered since the beginning of a browsing session.

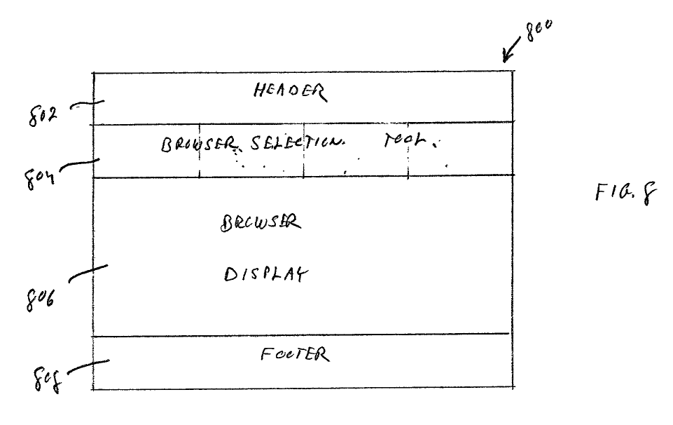

In the embodiment shown, the user interface layout is handled by using the <table> tag in HTML. FIG. 8 shows a possible layout 800. The layout 800 is split into four rows with the following information embedded in each section:

1. Header 802: contains a title bar or the like (e.g., “MP-WEB”).

2. Browser selection tool 804: shows the corresponding buttons and search fill-in form required for each browser.

3. Browser display 806: shows the content of the browser currently in action.

4. Footer 808: shows the credit and any other necessary information with possible links.

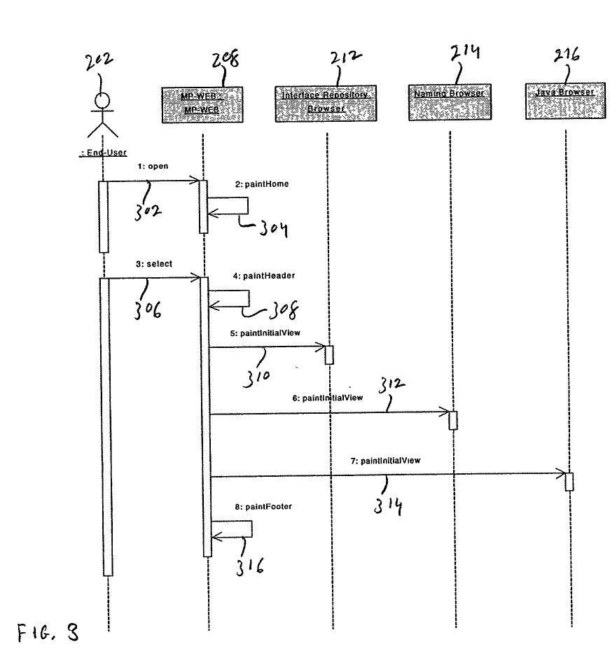

FIG. 3 is a sequence diagram showing the interaction required between objects to construct the final HTTP response 206 that the user receives at his or her end. It also shows when and how each of the components and sections that make up the final HTTP response 206 gets built.

As shown in the figure, the sequence begins when the end user 202 opens the MP-WEB browser by supplying from the Web browser 102 an HTTP request 204 containing a suitable URL, such as

http ://IPaddress/webapp/mpweb

where IPaddress represents the IP address of the Web server 106, either a domain name that is resolved by a domain name server (DNS) or a resolved IP address in quad-decimal format a.b.c.d, where a-d are each decimal numbers ranging between 0 and 255 (step 302). Web server 106, upon receiving the request HTTP 204, recognizes from the webapp/mpweb part of the URL that the request is intended for MP-WEB servlet 208 and directs it accordingly. Upon being opened, the MP-WEB servlet 208 constructs a home view using the function paintHome( ) (step 304). The home view is an HTML document that is sent back to the Web browser 102 as an HTTP response 206.

The end user 202 then selects a particular one of the browser servlets 212-216 by issuing a subsequent HTTP request 204 specifying a particular browser (step 306). This is typically performed by clicking on an area of the home view corresponding to the desired browser. Thus, to select the IR browser 212, the HTTP request 204 might contain the URL

http://IPaddress/webapp/mpweb/WWEB?browser=IR

where IPaddress is the IP address of the Web server 106. Similarly, to select the Naming browser 212, the HTTP request 204 might contain the URL

http://IPaddress/webapp/mpweb/MPWEB?browser-Naming

where IPaddress has the same significance as above. Likewise, to select the Java browser 212, the HTTP request 204 might contain the URL

http://IPaddress/webapp/mpweb/MPWEB?browser=Java

where IPaddress has the same significance as above.

For the particular browser view corresponding to the selected browser, MP-WEB servlet 208 constructs a header portion of an HTTP response 206 that is common to all of the browsers 212-216, using the function paintHeader( ) (step 308).

Using the function paintInitialview( ), MP-WEB servlet 208 then invokes the selected browser servlet (as determined from the URL of the HTTP request 204) to construct an initial view portion of the HTTP response 206 that is specific to that browser (steps 310-314). Thus, if the user has selected the IR browser 212, MP-WEB servlet 208 calls on the IR browser 212 to construct an initial view portion of the HTTP response 206 (step 310). Similarly, if the user has selected the Naming browser 214, MP-WEB servlet 208 calls on the Naming browser 214 to construct an initial view portion of the HTTP response 206 (step 312). Likewise, if the user has selected the Java browser 216, MP-WEB servlet 208 calls on the Java browser 216 to construct an initial view portion of the HTTP response 206 (step 314).

Finally, after having the selected browser construct an initial view portion of the HTTP response 206, MP-WEB uses the function paintFooter( ) to construct a footer portion of the HTTP response 206 which, like the header portion, is common to all of the browsers 212-214 (step 316).

End user access is through one interface, that of the Web browser 102, which is in HTML format. MP-WEB servlet 208 controls all the access to each of the specific browsers 212-216 that it supports. Since an HTTP response 206 goes back to the client browser 102 as a response to its HTTP request 204, any given HTTP request 204 that MP-WEB servlet 208 receives from the client will have been derived from the previous HTTP response 206, with a simple user interaction generated by a form submission and/or hyperlink clicks. This means that in its preferred form, the present invention is a completely dataless (i.e., stateless) transient object, with its only source of state information embedded in the HTTP request 204 itself In order to accomplish this subsystem construction, the present invention is designed to handle the request 204 using minimal information. The following is a list of information items that may be used to complete an end user request 204:

1. Target browser 212-216 of the request

2. Current name and value pair of the request for each browser 212-216 (in case of browser selection switches)

3. History of valid selections made for each browser 212-216 by the end user 202.

4. Name and value pair to be used as a parameter to the request.

Each of these items required for proper execution of a request can be embedded inside an HTTP request 204. Operation can be simplified once the MP-WEB servlet 208 gathers all the information that is required to construct the container of the response 206 and delegates the request 204 to a more specific browser servlet 212, 214 or 216, which then retrieves necessary information required to construct the information that can be sent back to the MP-WEB servlet 208.

The main architecture that complements the design of the present invention is derived from Model View Controller architecture. The present invention is event driven by an end user 202 accessing and interacting with it through the client-side Web browser 102. The main servlet 208 acts as the Controller that propagates the request to the browser servlets 212-216, which provide the View of the content by constructing the content for its browser display using its Model-like core class which interacts through the IR and Naming server objects 116 and 118 to retrieve all the necessary information and pass back to its View component, the browser servlet.

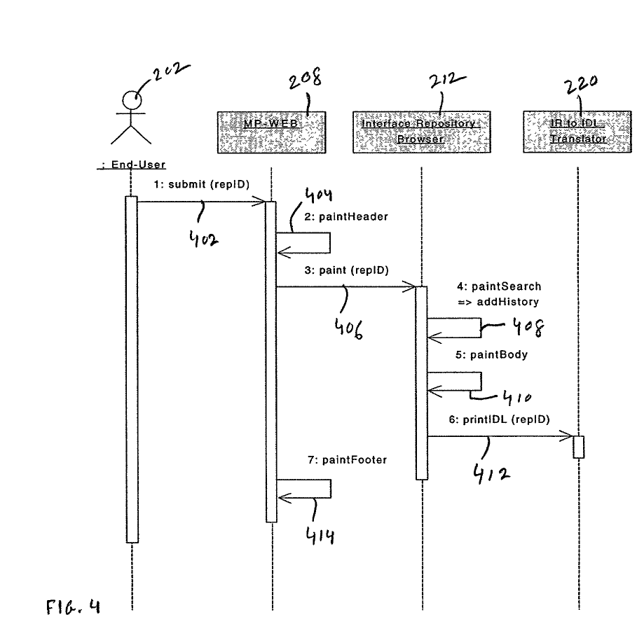

FIG. 4 shows the general interaction between the components of the present invention that occurs when processing a user request. While the particular example shown involves a request directed to the IR browser 212, the general flow is similar for a request directed to the Naming browser 214 or the Java browser 216.

In the example shown, the user initiates the sequence by submitting a repository ID (repID)) request—a particular form of HTTP request 204—via a form submission (step 402). In response to receiving this request, MP-WEB servlet 208 invokes the paintHeader( ) function to create the header portion of an HTTP response 206, in a manner similar to that described above (step 404). Invoking the function paint(repID), MP-WEB servlet 208 then calls on the IR browser 212 to construct a portion of the HTTP response 206 that is specific to the particular request (step 406).

Upon being called by MP-WEB servlet 208, IR browser 212 invokes the function paintsearch( ) to add the current query to a portion of the HTTP response 206 showing the search history (step 408). IR browser 212 then invokes a paintBody( ) function to construct the body portion of the HTTP response 206 (except for the query result itself) (step 410).

Thereafter, using a printIDL( ) function, IR browser 212 sends the query argument (repID) to the IR-to-IDL translator 220 (step 412). IR-to-IDL translator 220 generates the actual query that is sent to the IR server 116 via ORB 114 (FIG. 1). Upon receiving a query result back from the IR server 116, IR-to-IDL translator 220 forwards it on to IR browser 212. Upon receiving the query result back from IR-to-IDL translator 220, IR browser 212 adds the query result to the body portion of the HTTP response 206 that is being constructed.

Finally, upon receiving the browser-specific portion of the HTTP response 206 back from IR browser 212, MP-WEB servlet 208 invokes the paintFooter( )function to construct the footer portion of the HTTP response 206 (step 414), which is sent back to the Web browser 102 of the end user 202.

In a similar manner, Naming browser 214 and Java browser 216 use their respective translators 222 and 224 to handle actual distributed client/server requests through ORB 114. Each of these other requests follows a similar interaction sequence.

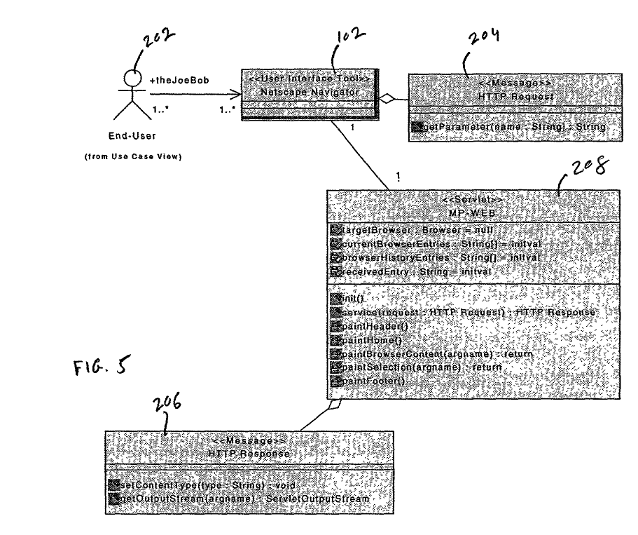

FIG. 5 is a generic class diagram of MP-WEB 208 and related components of the present invention. For further reference the classes shown in this figure are also shown as listings in Appendix A to this specification.

MP-WEB 208 is the main component of this set of components of the present invention. It services the end user 202 by processing an HTTP request 204 sent from the Web browser 102 and sending a post-process HTTP response 206 back to the Web browser 102. The Web browser 102 in turn renders the result in user-friendly display format from the HTML encoding. In the embodiment shown, MP-WEB 208 is implemented as a servlet that resides in the memory of the server machine and calls other browser servlets—specifically, IR browser servlet 212, Naming browser servlet 214, and Java browser servlet 216 in the embodiment shown—as needed to process the painting of the browser content in the HTTP response 206.

If desired, during init( ) function processing MP-WEB servlet 208 may start to load the other servlets 212-216 into memory if they are not already resident in memory. This servlet chaining process can possibly save some time, since a servlet can retain its initialization information in memory once it is loaded. During the init( ) call for the IR browser servlet 212 and the Naming browser servlet 214, ORB 114 can be initialized to retrieve pointers for the IR server 116 and Naming server 118 ahead of time.

As soon as the init( ) is complete, the service( ) method is called by the Web server 106 to pass the HTTP request 204 to be serviced. The MP-WEB servlet 208 then retrieves all the necessary data out of the HTTP request 204 and starts filling in the HTTP response 206. When the content of the HTTP response 206 needs to be filled in, the MP-WEB servlet 208 calls the browser servlet 212. 214 or 216 necessary to fill in the content.

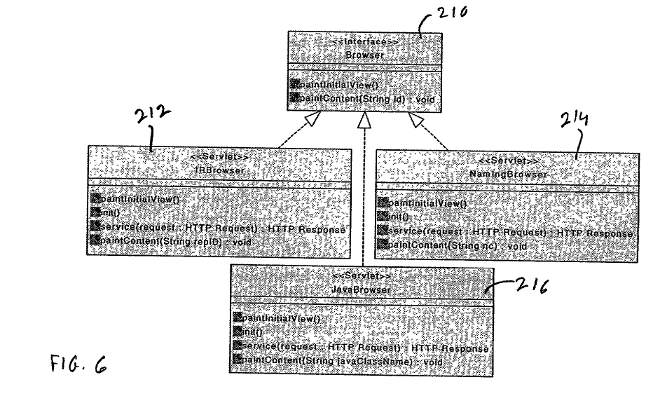

FIG. 6 is a class diagram of the browser components 210-216 of the present invention. (The browser classes are also shown in Appendix B.) As described above, these components comprise a generic browser interface (Browser) 210, together with specific instantiations of this generic browser interface as an IR browser servlet (IRBrowser) 212, a Naming browser servlet (NamingBrowser) 214, and a Java browser servlet (JavaBrowser) 216.

Each of the specific browsers 212-216 implements the generic browser interface 210, which includes the base functions paintInitialView( ) and paintContent(String id). The first of these functions paints an initial view, while the second that takes some identifier which specifies browser-specific entry information. The specific browsers 212-216 then just add the init( ) and service(HTTPRequest) functions, which are required by all the servlets. As described above, the init( ) function initializes the necessary Component Broker connections and ORB initialization, which can be saved across requests.

Initialization code may look something like the following:

//Initialize the CB/390 ORB & Repository

com.ibm.CBCUtil. CB SeriesGlobal.Initialize( );

orb =com.ibm.CBCUtil.CBSeriesGlobal.orb( );

org. omg.CORBA. Object obj=orb. resolve_initial_references(“InterfaceRepository”);

rep=org.omg.CORBA.RepositoryHelper.narrow(obj);

org.omg.CORBA.Current orbCurrent=orb.get_current(“CosTransactions::Current”);

currentTrans=org.omg.CosTransactions.CurrentHelper.narrow(orbCurrent);

This code shows that the orb, rep, and currentTrans global handles are cached in memory after the init( ) function has been called.

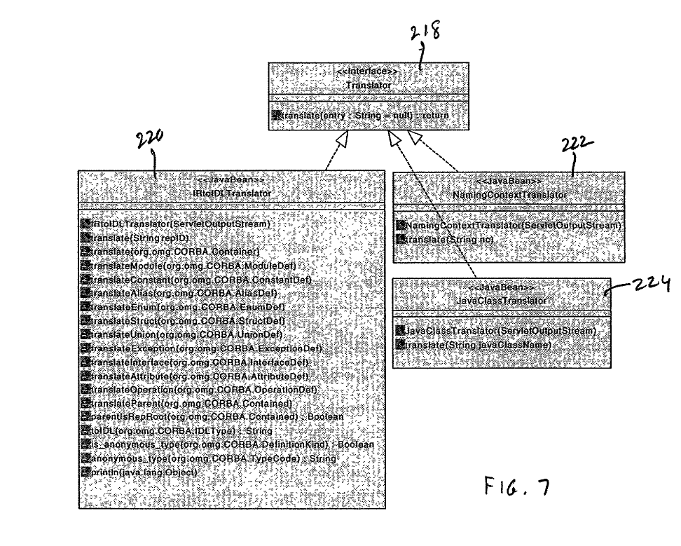

FIG. 7 is a class diagram of the translator components 218-224 of the present invention. (The translator classes are also shown in Appendix C.) As already described above, these components comprise a generic translator (Translator) 218, together with specific instantiations of this generic translator as an IR-to-IDL translator (IRtoIDLTranslator) 220, a Naming context translator (NingContextTranslator) 222, and a Java class translator (JavaClassTranslator) 224.

Translator components 220-224 have all the actual application programming interfaces (APIs) for calling the backend servers 116 and 118 (FIG. 1) to retrieve information and for translating it into valid HTML document content that can be embedded within the portion of the HTTP response 206 that is being constructed by the browser component. The corresponding browser components 212-214 construct portions such as the outside frames and other necessary information that are not specific to a request, while translators 220-224 construct the request-specific content that is the object of the present invention. The Naming browser 214 and the Java class browser 216 are implemented in a similar fashion to attach the ServletOutputStream through the constructor. When the translate(String) functions of the translators 220-224 are called, they call their private methods to translate the requested content into HTML document content.

While a particular embodiment has been shown and described, various modifications and extensions will be apparent to those skilled in the art. Thus, while a particular hypertext protocol (HTTP) and hypertext document format (HTML) have been used in the embodiment shown, other document formats such as XML (eXtensible Markup Language) and other hypertext protocols could be used instead. Further, while browsers for retrieving particular objects have been described, other types of objects could be retrieved besides the ones described. Finally, while the browser components are implemented as servlets while the translator components are implemented as JavaBeans in the embodiment shown, other forms of implementation could be used instead.

### APPENDIX A

### MP-WEB Classes

HTTP Response

setContentType(type: String):void

getOutputStream(argname):ServletOutputStream

HTTP Request

getParameter(name:String):String

MP-WEB

targetBrowser: Browser=null

currentBrowserEntries:String[]=initval

browserHistoryEntries:String[]=initval

receivedEntry:String=initval

init( )

service(request:HTTP Request):HTTP Response

paintHeader( )

paintHome( )

paintBrowserContent(argname):return

paintSelection(argname):return

paintFooter( )

### APPENDIX B

### Browser Classes

Browser

paintInitialView( )

paintContent(String id) void

IRBrowser

paintInitialView( )

init( )

service(request HTTP Request) HTTP Response

paintContent(String repID):void

NamingBrowser

paintInitialView( )

init( )

service(request:HTTP Request):HTTP Response

paintContent(String nc):void

JavaBrowser

paintInitialview( )

init( )

service(request:HTTP Request):HTTP Response

paintContent(String javaClassName):void

### APPENDIX C

### Translator Classes

Translator

translate(entry:String=null):return

IRtoIDLTranslator

IRtoIDLTranslator(ServletOutputStream)

translate(String repID)

translate(org.omg.CORBA.Container)

translateModule(org.omg.CORBA.ModuleDef)

translateConstant(org.omg.CORBA.ConstantDef)

translateAlias(org.omg.CORBA.AliasDef)

translateEnum(org.omg.CORBA.EnumDef)

translateStruct(org.omg.CORBA. StructDef)

translateUnion(org.omg.CORBA.UnionDef)

translateException(org.omg.CORBA.ExceptionDef)

translateInterface(org.omg.CORBA.InterfaceDef)

translateAttribute(org. omg. CORBA.AttributeDef)

translateOperation(org. omg.CORBA.OperationDef)

translateParent(org. omg.CORBA. Contained)

parentIsRepRoot(org. omg.CORBA. Contained): Boolean

toIDL(org.omg.CORBA.IDLType): String

is_anonymous_type(org.omg.CORBA.DefinitionKind): Boolean

anonymous_type(org.omg.CORBA.TypeCode):String

printIn(java.lang. Object)

NamingContextTranslator

NamingContextTranslator(ServletOutputStream)

translate(String nc)

JavaClassTranslator

JavaClassTranslator(ServletOutputStream)

translate(String javaClassName)

What is claimed is:

1. A hypertext browser for retrieving data from a selected one of a plurality of databases, comprising:
a plurality of browser components, each of which is operable to retrieve data from a corresponding one of said databases;
means for receiving a hypertext request from a requester specifying data contained in one of said databases;
means responsive to receiving said request for directing said request to the browser component corresponding to said one of said databases to permit said browser component to retrieve the data specified in said request.

2. The apparatus of claim 1 in which said request specifies one of said browser components, said means responsive to receiving said request directing said request to the browser component specified in said request.

3. The apparatus of claim 1 in which said means responsive to said request generates a common portion of a hypertext reply to said requester.

4. The apparatus of claim 3 in which said common portion comprises a header portion.

5. The apparatus of claim 3 in which said common portion comprises a footer portion.

6. The apparatus of claim 1 in which each of said browser components generates a browser-specific portion of a hypertext reply to said requester.

7. The apparatus of claim 1 in which each of said browser components has a translator component associated therewith, said translator component intermediating between said browser component and said database and generating a request-specific portion of said browser-specific portion of said hypertext reply to said requester.

8. The apparatus of claim 7 in which said browser component generates a non-request-specific portion of said browser-specific portion of said hypertext reply to said requester.

9. The apparatus of claim 1 in which one of said databases comprises an interface repository.

10. The apparatus of claim 1 in which one of said databases stores naming contexts.

11. The apparatus of claim 1 in which one of said databases stores Java classes.

12. A method for retrieving data from a selected one of a plurality of databases, comprising the steps of:
providing a plurality of browser components, each of which is operable to retrieve data from a corresponding one of said databases;
receiving a hypertext request from a requester specifying data contained in one of said databases;
in response to receiving said request, directing said request to the browser component corresponding to said one of said databases to permit said browser component to retrieve the data specified in said request.

13. The method of claim 12 in which said request specifies one of said browser components and is directed to the browser component specified in said request.

14. The method of claim 1 in which each of said browser components generates a browser-specific portion of a hypertext reply to said requester.

15. The method of claim 1 in which each of said browser components has a translator component associated therewith, said translator component intermediating between said browser component and said database and generating a request-specific portion of said browser-specific portion of said hypertext reply to said requester.

16. The method of claim 15 in which said browser component generates a non-request-specific portion of said browser-specific portion of said hypertext reply to said requester.

17. The method of claim 12 in which one of said databases comprises an interface repository.

18. The method of claim 12 in which one of said databases stores naming contexts.

19. The method of claim 12 in which one of said databases stores Java classes.

20. A program storage device readable by a machine, tangibly embodying a program of instructions executable by the machine to perform method steps for retrieving data from a selected one of a plurality of databases, said method steps comprising:
providing a plurality of browser components, each of which is operable to retrieve data from a corresponding one of said databases;
receiving a hypertext request from a requester specifying data contained in one of said databases;
in response to receiving said request, directing said request to the browser component corresponding to said one of said databases to permit said browser component to retrieve the data specified in said request.

21. The program storage device of claim 20 in which said request specifies one of said browser components and is directed to the browser component specified in said request.

22. The program storage device of claim 20 in which each of said browser components generates a browser-specific portion of a hypertext reply to said requester.

23. The program storage device of claim 20 in which each of said browser components has a translator component associated therewith, said translator component intermediating between said browser component and said database and generating a request-specific portion of said browser-specific portion of said hypertext reply to said requester.

24. The program storage device of claim 23 in which said browser component generates a non-request-specific portion of said browser-specific portion of said hypertext reply to said requester.

25. The program storage device of claim 20 in which one of said databases comprises an interface repository.

26. The program storage device of claim 20 in which one of said databases stores naming contexts.

27. The program storage device of claim 20 in which one of said databases stores Java classes.
